(19) United States
(12) Patent Application Publication
(10) Pub. No.: US 2002/0166042 A1
(43) Pub. Date: Nov. 7, 2002

(54) Speculative branch target allocation

(76) Inventors: Yoav Almog, Kiryat Haim/Haifa (IL); Ronny Ronen, Haifa (IL)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/847,068

(22) Filed: May 1, 2001

(51) Int. Cl. G06F 9/00

(52) U.S. Cl. 712/238

(57) ABSTRACT

A method and apparatus for improving branch prediction, the method including determining a target of a branch instruction; storing the target of the branch instruction before the branch instruction is fully executed; and re-encountering the branch instruction and predicting a target for the branch instruction by accessing the stored target for the branch instruction.

### FIELD OF THE INVENTION

This invention relates generally to microprocessors, and more particularly to branch prediction.

### BACKGROUND

Microprocessors often employ the use of pipelining to enhance performance. Within a pipelined microprocessor, the functional units necessary for executing different stages of an instruction operate simultaneously on multiple instructions to achieve a degree of parallelism leading to performance increases over non-pipelined microprocessors.

As an example, an instruction fetch unit, a decoder, and an execution unit may operate simultaneously. During one clock cycle, the execution unit executes a first instruction while the decoder decodes a second instruction and the fetch unit fetches a third instruction. During the next clock cycle, the execution unit executes the newly decoded instruction while the decoder decodes the newly fetched instruction and the fetch unit fetches yet another instruction. In this manner, neither the fetch unit nor the decoder need to wait for the execution unit to execute the last instruction before processing new instructions. In some microprocessors, the steps necessary to fetch and execute an instruction are sub-divided into a larger number of stages to achieve a deeper degree of pipelining.

A pipelined Central Processing Unit (“CPU”) operates most efficiently when the instructions are executed in the sequence in which the instructions appear in the program. Unfortunately, this is typically not the case. Rather, computer programs typically include a large number of branch instructions, which, upon execution, may cause instructions to be executed in a sequence other than as set forth in the program.

More specifically, when a branch instruction is encountered in the program flow, execution continues either with the next sequential instruction or execution jumps to an instruction specified as the “branch target”, which is calculated by the decoder. Typically the branch instruction is said to be “Taken” if execution jumps to an instruction other than the next sequential instruction and “Not Taken” if execution continues with the next sequential instruction.

After the decoder calculates the branch target, the execution unit executes the jump and subsequently allocates (e.g., stores) the branch target within the Branch Prediction Unit (“BPU”) so that the BPU can predict the branch target upon re-encountering the branch instruction at a later time.

When a branch prediction mechanism predicts the outcome of a branch instruction and the microprocessor executes subsequent instructions along the predicted path, the microprocessor is said to have “speculatively executed” along the predicted instruction path. During speculative execution, the microprocessor is performing useful processing only if the branch instruction was predicted correctly. However, if the BPU mispredicted the branch instruction, then the microprocessor is speculatively executing instructions down the wrong path and therefore accomplishes nothing useful.

When the microprocessor eventually detects that the branch instruction was mispredicted, the microprocessor must flush all the speculatively executed instructions and restart execution at the correct address. Since the microprocessor accomplishes nothing when a branch instruction is mispredicted, it is very desirable to accurately predict branch instructions. This is especially true for deeply pipelined microprocessors wherein a long instruction pipeline will be flushed each time a branch misprediction is made. This presents a large misprediction penalty.

As mentioned above, branch targets are currently allocated to the BPU after execution. Thus, the BPU does not have the calculated branch target if the branch instruction is re-encountered (several times perhaps, if the branch instruction is part of a small loop) before the first occurrence of the branch instruction has been fully executed. This can decrease performance since the BPU may mispredict the branch target several times before the branch target is allocated to the BPU. These mispredictions, in turn, create large misprediction penalties in systems which have a large architectural distance between the decoder and the execution unit and for programs which rely heavily on small loops.

### DESCRIPTION OF THE DRAWINGS

Various embodiments are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a flow chart of a method of predicting a branch target.

FIG. 2 is a diagram of a system which includes a cache to improve branch prediction.

### DETAILED DESCRIPTION

Various embodiments disclosed herein overcome the problems in the existing art described above by providing a method and apparatus which utilize a cache to improve branch target prediction. In the following description, for the purposes of explanation, numerous specific details are set forth in order to provide a thorough understanding of the various embodiments. It will be apparent, however, to one skilled in the art that the embodiments may be practiced without some of these specific details. The following description and the accompanying drawings provide examples for the purposes of illustration. However, these examples should not be construed in a limiting sense as they are merely intended to provide exemplary embodiments rather than to provide an exhaustive list of all possible implementations. In other instances, well-known structures and devices are shown in block diagram form in order to avoid obscuring the details of the various embodiments.

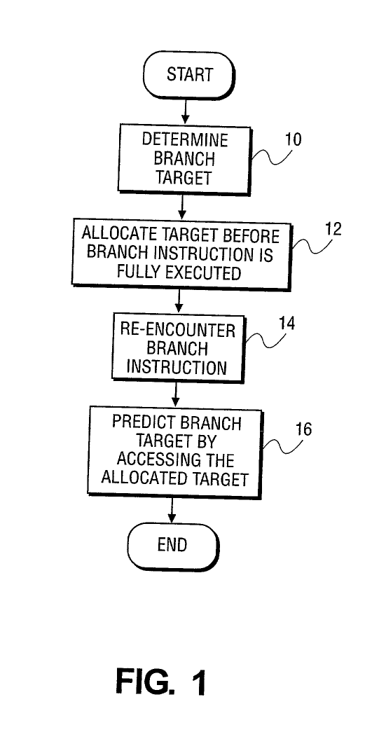

Referring now to FIG. 1, a flow chart is shown which illustrates the manner in which an embodiment improves branch prediction. Initially, a branch target for a branch instruction is determined at block 10. In an embodiment, a decoder is used to determine the target for the branch instruction. The target is then allocated (e.g., stored) at block 12 before the branch instruction is fully executed. In an embodiment, allocating the target at block 12 includes saving the target to a cache, other fast memory, or the like. At blocks 14 and 16 respectively, the branch instruction is re-encountered, and the branch target is predicted by accessing the allocated target. In this manner, branch prediction is improved since the prediction can occur prior to complete execution of the first occurrence of the branch instruction. This is of even greater importance when processing programs which are highly dependent on small loops since a branch instruction may be re-encountered several times before the initial occurrence has been fully executed. Thus, multiple target mispredictions can be avoided.

In an embodiment, the branch target is also stored in a Branch Prediction Unit (“BPU”) after the branch instruction has been fully executed. This facilitates prediction of branch targets when the same branch instruction is subsequently re-encountered. However, various embodiments, which include additionally storing the branch target in the BPU, contemplate predicting the target before the target is stored in the BPU. For instance, a target for a branch instruction is determined, and the target is allocated (e.g., to a cache) before execution of the branch instruction is completed. Subsequent to the initial allocation and while the first occurrence of the branch instruction is being executed, the branch instruction is re-encountered, and the target is predicted by accessing the stored target. Finally, after the first occurrence of the branch instruction is fully executed, the target is additionally allocated to the BPU for future predictions.

In various embodiments, future predictions which involve the BPU as well as the cache proceed as follows. Upon re-encountering the branch instruction, the BPU accesses (e.g., a lookup) the cache and the branch target buffer located within the BPU for targets. The BPU prioritizes the targets obtained from the cache and the branch target buffer and generates a prediction based on the prioritized targets. In some embodiments, after the branch target has been allocated to the BPU, the branch target continues to be allocated to the cache and/or the BPU as the branch instruction is re-encountered. In other embodiments, after the branch target has been allocated to the BPU, the branch target is no longer allocated to the cache once the target for that branch instruction has been allocated to the BPU.

It should be noted that the branch instruction can be a direct branch and/or a backward branch. A direct branch is a branch which enables the target address to be calculated by the decoder. Thus, the target may be immediately allocated once it is determined, rather than waiting to allocate after execution of the branch instruction. A backward branch is a branch which is a loop, and therefore, the branch instruction would be expected to reoccur. As such, allocating the target of a backward branch in anticipation of re-encountering the branch instruction improves branch prediction.

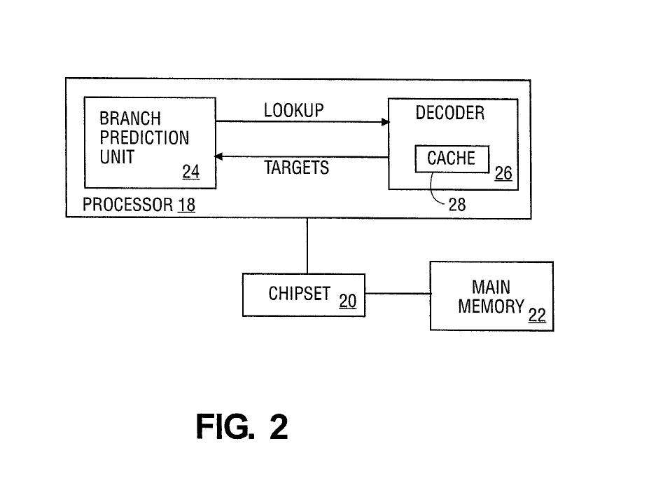

Turning now to FIG. 2, a system is shown which illustrates the components which comprise an embodiment for improving branch prediction. It should be noted that various components have been omitted in order to avoid obscuring the details of the embodiment shown. The system includes a processor 18 capable of pipelining instructions coupled to a chipset 20 and a main memory 22. The processor 18 includes a BPU 24 and a decoder 26. The decoder 26 has a cache 28 disposed within the decoder 26. Although the embodiment shown in FIG. 2 has the cache 28 disposed within the decoder 26, it is contemplated to have the cache 28 located elsewhere within the system.

In accordance with various embodiments discussed above, the decoder 26 determines the branch target for a branch instruction and allocates the target to the cache 28. While the processor 18 is executing the branch instruction, the branch instruction is re-encountered. The BPU 24 predicts the target by conducting a lookup to the cache 28 within the decoder 26 in order to obtain the target previously allocated to the cache 28. As the BPU 24 does not have a target stored in its branch target buffer (not shown), the BPU predicts the target obtained from the cache 28.

If, however, the BPU 24 also has a target stored in its branch target buffer, the BPU 24 will prioritize the target obtained from the cache 28 and the target obtained from the BPU branch target buffer. Once prioritized, the BPU 24 will generate a final prediction based on the prioritized targets.

It is to be understood that even though numerous characteristics and advantages of various embodiments have been set forth in the foregoing description, together with details of the structure and function of the various embodiments, this disclosure is illustrative only. Changes may be made in detail, especially matters of structure and management of parts, without departing from the scope of the present invention as expressed by the broad general meaning of the terms of the appended claims.

We claim:

1. A method comprising:
determining a target of a branch instruction;
storing the target of the branch instruction before the branch instruction is fully executed; and
re-encountering the branch instruction and predicting a target for the branch instruction by accessing the stored target for the branch instruction.

2. The method of claim 1, wherein the branch instruction is a direct branch.

3. The method of claim 1, wherein the branch instruction is a backward branch.

4. The method of claim 1, wherein storing the target comprises saving the target to a cache.

5. The method of claim 4, wherein the target of the branch instruction is also stored in a branch prediction unit after the branch instruction has been fully executed.

6. The method of claim 5, wherein the target is predicted for the branch instruction before the target of the branch instruction is stored in the branch prediction unit.

7. The method of claim 6, wherein predicting a target for the branch instruction comprises:
accessing at least one target stored in at least one of the cache and the branch prediction unit;
prioritizing the accessed targets; and
generating a branch prediction based on the prioritized targets.

8. An apparatus comprising:
a decoder to determine a target of a branch instruction;
a cache to store the target of the branch instruction before the branch instruction is fully executed; and
a branch prediction unit to, upon re-encountering the branch instruction, predict the target of the branch instruction by accessing the target of the branch instruction stored in the cache.

9. The apparatus of claim 8, wherein the decoder determines a target of a direct branch instruction.

10. The apparatus of claim 8, wherein the decoder determines a target of a backward branch instruction.

11. The apparatus of claim 8, wherein the branch prediction unit also stores the target of the branch instruction after the branch instruction has been fully executed.

12. The apparatus of claim 11, wherein the branch prediction unit predicts the target for the branch instruction before the target of the branch instruction is stored in the branch prediction unit.

13. The apparatus of claim 12, wherein the branch prediction unit predicts the target for the branch instruction by:
accessing at least one target stored in at least one of the cache and the branch prediction unit;
prioritizing the accessed targets; and
generating a branch prediction based on the prioritized targets.

14. A system comprising:
a processor capable of pipelining instructions;
a decoder to determine a target of a branch instruction to be executed by the processor;
a cache to store the target of the branch instruction before the branch instruction is fully executed by the processor; and
a branch prediction unit to, upon re-encountering the branch instruction, predict the target of the branch instruction by accessing the target of the branch instruction stored in the cache.

15. The system of claim 14, wherein the decoder determines a target of a direct branch instruction.

16. The system of claim 14, wherein the decoder determines a target of a backward branch instruction.

17. The system of claim 14, wherein the branch prediction unit also stores the target of the branch instruction after the branch instruction has been fully executed.

18. The system of claim 17, wherein the branch prediction unit predicts the target for the branch instruction before the target of the branch instruction is stored in the branch prediction unit.

19. The system of claim 18, wherein the branch prediction unit predicts the target for the branch instruction by:
accessing at least one target stored in at least one of the cache and the branch prediction unit;
prioritizing the accessed targets; and
generating a branch prediction based on the prioritized targets.
